(19) United States
(12) Patent Application Publication
(10) Pub. No.: US 2024/0414468 A1
(43) Pub. Date: Dec. 12, 2024

(54) HEADPHONES AND HEADBAND

(71) Applicant: HEDD Audio GmbH, Berlin (DE)

(72) Inventor: Markus PÜSCHEL, Berlin (DE)

(21) Appl. No.: 18/739,475

(22) Filed: Jun. 11, 2024

(30) Foreign Application Priority Data
Jun. 12, 2023 (DE) 102023115289.0

(51) Int. Cl. H04R 1/10

(52) U.S. Cl. CPC H04R 1/105; H04R 1/1008

(57) ABSTRACT

Disclosed is a headband for headphones, comprising a flexurally elastic element extending in an arc from one end to the other, for holding an earcup at at least one of its ends. A flexible support band having a section configured to rest on the head of a wearer of the headband is suspended from the headband element on the concave inner side of the headband element. The suspended section has an adjustable length. The adjustment allows the headband to be adapted to different head sizes and shapes.

### CROSS-REFERENCE TO RELATED APPLICATIONS

This application claims the benefit and priority of German Patent Application No. 102023115289.0 filed on Jun. 12, 2023, the disclosure of which is incorporated herein by reference in its entirety.

### FIELD

The invention relates to headphones, in particular to on-ear (supra-aural) or over-ear (circumaural) headphones, and to a headband for such headphones.

### BACKGROUND

Headphones should, on the one hand, fit tightly enough to prevent them from slipping during head movement and, on the other hand, they should not exert excessive pressure on the head and ears so that they can be worn comfortably for long periods of time. Both requirements should also be met for a wide range of different head sizes and shapes. However, these requirements have been difficult to meet in the past, especially for headphones with high-quality sound transducers, which often have a relatively high weight.

U.S. Pat. No. 10,764,672 B2 discloses headphones with an adjustable headband. The headband comprises a flexurally elastic headband element, for example made of spring wire, at each end of which an earcup with a sound transducer is hinged and which provides contact pressure of the earcups on the wearer's ears. The headband element also carries two slides near its ends, between which a flexible band extends, e.g. made of leather, which rests on top of the wearer's head and is intended to bear part of the weight of the headphones. The slides can be moved along the headband element either closer to or further away from the earcups so that the distance between the band resting on the head and the earcups positioned at ear level can be adjusted to different head sizes.

RO 134602 AO discloses an example of such flexible band where, specifically, the band ends are stiffened by steel strips that guide the band towards the head of the wearer so that it should fit as closely as possible to a slim head.

However, the adaptability of known headbands to individual head sizes and shapes is limited. The known solutions can essentially be adjusted only in height to the respective head size. Further adaptability to different head widths and shapes can hardly be accomplished thereby. The contact pressure of the earcups on the head and ears provided by the flexurally elastic headband element depends on its elastic deformation and is usually perceived as too high by wearers with a wide head and too loose by those with a narrow head. For this reason, conventional headphones are often not comfortable enough to wear.

### SUMMARY

It is, therefore, an object of the invention to provide a headband and a headphone provided with such headband, which offer improved wearing comfort for a variety of different head shapes and sizes.

This object is solved by a headband and by a headphone as set forth in the appended claims.

In an exemplary embodiment, the invention makes it possible to adapt the headband to different head sizes and shapes while always distributing the forces acting on the wearer's head as evenly as possible and thus always providing good wearing comfort. In an exemplary embodiment, the invention relates to features, in particular for adapting the headband to different head heights of the wearer. In an exemplary embodiment, the invention relates to features, in particular for adapting the headband to different head widths and shapes of the wearer.

### BRIEF DESCRIPTION OF THE DRAWINGS

Preferred embodiments of the invention are shown in the accompanying drawings, wherein:

FIG. 1 shows a schematic view of a headband in a cross section in the frontal plane.

FIG. 2 is a partial perspective view of headphones comprising the headband shown in FIG. 1.

### DETAILED DESCRIPTION

Identical elements are provided with the same reference signs in all figures without being explained again for each figure. The positional and directional terms used here, such as “left”, “right”, “lateral”, “median”, “top”, “bottom”, “frontal”, etc. correspond to the standard anatomical terms of location and direction of the wearer of the headphones when used as intended. The left and right sides of the headband are essentially symmetrical with respect to the median plane and explanations on one side also apply to the other. Similar elements on the left and right of the headphones or headband are designated by the same reference signs with the addition of the letters L and R, and explanations that mention both reference signs apply to each of the two sides.

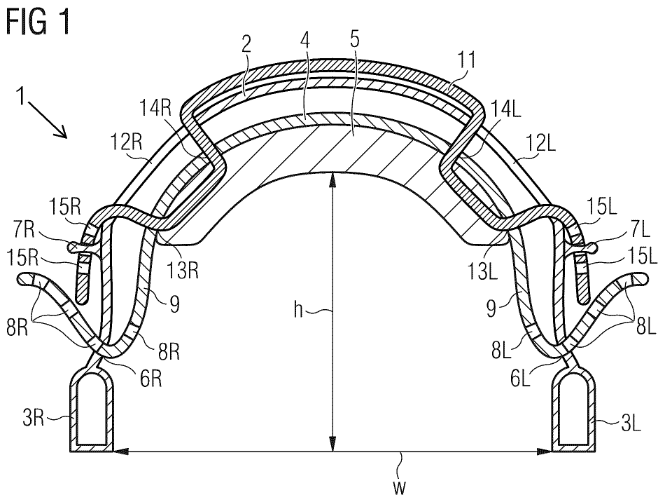

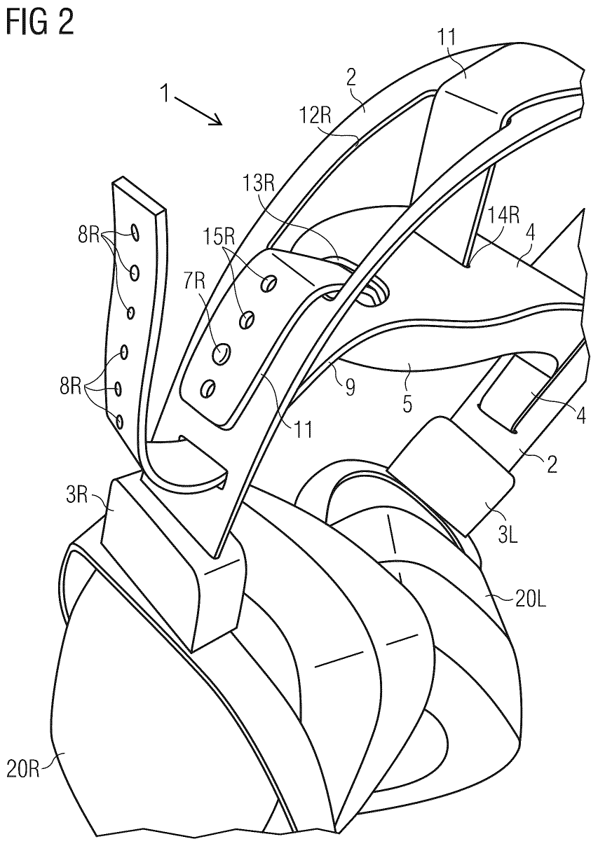

FIG. 1 shows a headband 1 schematically in a cross section through the central frontal plane, as a view of this plane from the front. The headband 1 comprises a flexurally elastic headband element 2 which extends in an arc for wearing over the wearer's head and is provided at each of its two ends, i.e. approximately at the ends of the arc on its left and right sides, with an attachment device 3L, 3R for attachment of an earcup (20L, 20R in FIG. 2; not shown in FIG. 1).

On the concave inner side (the underside) of the headband element 2, the headband 1 comprises a flexible support band 4 which, when in use, rests on the wearer's head to support the weight of the headphones. For a comfortable fit, the underside of the support band 4 facing the head is preferably provided with a soft cushion 5 for padded support on the wearer's head.

The support band 4 is suspended at the ends of the headband element 2, close to the attachment devices 3L, 3R on suspensions 6L, 6R on the headband element 2 in such a way that the length of its suspended section 9 extending between the left and right suspensions 6L, 6R is adjustable. The section 9 is also the section of the support band 4 that is to rest on a wearer's head in use of the headphones and is preferably provided with the cushion 5.

The adjustment of the length of the section 9 adjusts the height h of the center of the support band 4, or of the underside of its cushion 5, above the underside of the attachment devices 3L, 3R. The center here is the center lying on the median plane. In this way, the adjustability allows the headband to be adapted to the size or height of the wearer's head. specifically, when the center of the support band 4 or its cushion 5 rests on the top of the wearer's head, the adjustability allows its height above the earcups to be adapted to the height of the top of the head above the wearer's cars. During the adjustment, the suspensions 6L, 6R remain stationary far down at the ends of the head-band element 2, so that even when the length of the section 9 of the support band 4 is adjusted, the greatest possible length of the support band 4 is always in contact with the wearer's head and the forces of the headphones, in particular their weight, are distributed over a large part of the wearer's head surface for any head size.

Adjustment of the length of the section 9 may be achieved by folding the section 9 in or winding it up or the like. In the present embodiment, however, the suspensions 6L, 6R are guides 6L, 6R, through which the support band 4 can be pulled through to a greater or lesser extent as desired and can be fixed as selected by means of corresponding locking devices 7L, 7R provided on the headband element 2, so that the section 9 assumes the desired length. In this embodiment, the guides 6L, 6R are openings 6L, 6R in the headband element 2 and the locking devices 7L, 7R can be manually actuated on the outer convex side of the headband element 2 for fastening and unfastening the ends of the support band 4 which have been pulled through the openings 6L, 6R. By further pulling the support band 4 through the guides 6L, 6R from the inside to the outside, the section 9 of the support band 4 inside the curved headband element 2 is shortened and the height h is reduced, and vice versa in a corresponding manner.

The locking devices 7L, 7R for the support band can be designed, for example, as clamping devices for clamping the ends of the support band 4 to the headband element 2, as Velcro fasteners, as buckles or as combinations of hooks and eyes. In the present case, the locking devices 7L, 7R each comprise a pin 7L, 7R with a slightly thickened head projecting outwards from the convex outer side of the headband element 2 on each of the left and right sides of the headband element 2. The support band 4 is provided near each of its ends with a plurality of holes 8L, 8R through any of which the respective pin 7L, 7R can be inserted as desired, and the support band 4 can thus be buttoned over the pin 7L, 7R at a selected position.

The headband 1 also comprises a flexible tensioning strap 11 between the headband element 2 and the support band 4, with which the width of the headband 1 in lateral, i.e. left-right, direction and the shape of the support band 4 can be adjusted and adapted to the head width and head shape of the individual wearer.

The tensioning strap 11 is suspended on the respective left and right sides of the head-band 1 above the guides 6R, 6L on suspensions 12L, 12R on the headband element 2 in such a way that the length of a section of the tensioning strap 11 extending between the left and right suspensions 12L, 12R can be adjusted.

The adjustability here allows the free distance or width w in the lateral direction between the left and right attachment devices 3L, 3R, and thus the width of the headband 1 and the mutual distance between the earcups mounted on it, to be adapted to the head width of the individual wearer. This allows the elastic headband element 2 to be designed with a comfortable, not too strong contact pressure on the cars of wearers with a wide head, and the contact pressure to be readjusted using the tensioning strap 11 for wearers with a slim head.

Adjustment of the length of the suspended section of the tensioning strap 11 may be achieved by folding the section in or winding it up or the like. In the present embodiment, however, the suspensions 12L, 12R are guides 12L, 12R, through which the tensioning strap 11 can be pulled through to a greater or lesser extent as desired and can be fixed as selected by means of corresponding locking devices 7L, 7R provided on the headband element 2, so that the suspended section of the tensioning strap 11 assumes the desired length. In this embodiment, the guides 12L, 12R are openings 12L, 12R in the headband element 2 above the openings 6L, 6R, and the locking devices 7L, 7R can be actuated manually on the outer convex side of the headband element 2 for fastening and unfastening the ends of the tensioning strap 11 having been pulled through the openings 12L, 12R. By pulling the tensioning strap 11 further outwards through the guides 12L, 12R, the width w is reduced and vice versa.

The locking devices 7L, 7R for the tensioning strap 11 can be designed, for example, as clamping devices for clamping the ends of the tensioning strap 11 to the headband element 2, as Velcro fasteners, as buckles or as combinations of hooks and eyes. In the present case, the locking devices 7L, 7R each comprise a pin 7L, 7R with a slightly thickened head projecting outwards from the convex outer side of the headband element 2 on each side, left and right, of the headband element 2. The tensioning strap 11 is provided near each of its ends with a plurality of holes 15L, 15R through any of which the respective pin 7L, 7R can be inserted as desired and the tensioning strap 11 can thus be buttoned over the pin 7L, 7R at a selected position.

The locking devices for the support band 4 and the locking devices 7L, 7R for the tensioning strap 11 may be different from each other. But in the present embodiment, more simply, the pin 7L, 7R on the respective side of the headband 1 that serves as a locking device for the tensioning strap 11 is the same pin 7L, 7R on this side that also serves as a locking device for the support strap 4, and the tensioning strap 11 and the support band 4 are simply buttoned over this pin 7L, 7R one after the other. FIG. 1 shows the tensioning strap 11 buttoned onto the pin 7L, 7R and the support band 4 immediately ready to be buttoned thereover.

In this example, the tensioning strap 11 runs back and forth between the headband element 2 and the support band 4. The tensioning strap 11 and the support band 2 are coupled to each other so that they can be displaced relative to each other along the length of the support band, i.e. in lateral direction. Due to the displaceability, the bending shape of the support band 4 and thus the shape of the cushion 5 can be adapted to different head shapes. In addition, an adjustment of the support band 4 towards a reduction in the height h also leads to a tightening of the tensioning strap 11 and thus simultaneously to a certain reduction in the width w and vice versa. Adaptation to a different head size with different height and width both, can therefore be achieved in many cases simply by adjusting the support band 4 alone, without having to adjust the height and width of the headband 1 separately by separate adjustment of also the tensioning strap 11.

In detail, the tensioning strap 11 in the present example runs from the locking device 7R on the convex outer side of the headband element 2 through the opening 12R in the headband element 2 to the headband's concave inner side and on to the support band 4, passes through an opening 13R in the support band 4, through a further higher opening 14R in the support band 4 back towards the headband element 2, through the opening 12R in the headband element 2 to the headband's convex outer side, follows the outer side over the highest point in the median center of the headband element 2, passes through the opening 12L in the headband element 2 again to the headband's concave inner side and on to the support band 4, passes through an opening 14L in the support band 4, through a further lower opening 13L in the support band 4 back towards the headband element 2 and through the headband's opening 12L to the locking device 7L on the convex outer side of the headband element 2.

The headband element 2 is made of a flexurally elastic material with bending elasticity under the forces experienced by headphones in normal use, for example of a strip of steel or plastic, in particular fiber-reinforced plastic, preferably carbon fiber-reinforced plastic in terms of weight and elasticity. The support band 4 and the tensioning strap 11 are made of a flexible textile, film or leather material. For example the support band 4 is made of leather and the tensioning strap 11 is made of a textile fabric or textile belt. Both can have tensile elasticity to a certain extent; in this example, however, they are essentially non-elastic under tensile forces that occur in headphones under normal use. In particular, the support band 4 is essentially non-elastic in order to securely support even relatively heavy headphones and maintain the fit once it has been set. With regard to flexibility and broad distribution of weight and of other forces on the wearer's head, the band and strap and in particular the support band 4 have a flat rectangular cross-section. However, they need not be bands with a flat cross-section; the terms “band” and “strap” are also intended to include other cross-sections such as round or square cross-sections as of a cord or string or wire. The cushion 5 is made of foam and preferably has a foam filling and a soft leather, foil or textile cover.

FIG. 2 shows a partial perspective view of headphones with the headband 1 of FIG. 1. The headphones have two earcups 20L, 20R, which are attached to the two attachment devices 3L, 3R of the headband 1, respectively. The earcups 20L, 20R each comprise a sound transducer. They can be designed as on-car or over-car earcups 20L, 20R. For certain applications, there can also be only one earcup on the right or left side, to keep the opposite car open.

### REFERENCE NUMERALS

1 Headband
2 Element, headband element
3L, 3R Attachment device
4 Support band
5 Cushion
6L, 6R Suspension, guide, first guide, opening, first opening (in headband element)
7L, 7R Locking device, pin
8L, 8R Hole (in support band)
9 Section, suspended section (of support band)
11 Tensioning strap
12L, 12R Suspension, guide, second guide, opening, second opening (in headband element)
13L, 13R Opening (in support band)
14L, 14R Opening (in support band)
15L, 15R Hole (in tensioning strap)
20L, 20R Earcup

What is claimed is:

1. A headband for headphones, comprising:
a flexurally elastic headband element which extends in the shape of an arc having a convex outer side and a concave inner side, and which has at least one of its ends configured for holding an earcup, and
a flexible support band configured to rest on the head of a wearer of the headband and including a section suspended at its two ends from the headband element on the concave inner side, wherein said section has an adjustable length.

2. A headband in accordance with claim 1, wherein:
the headband element is provided, near at least one of its ends, with a first guide through which a selectable length of the support band is passed, and
the headband element is provided with a locking device for locking the support band passed through the first guide, thereby fixing said selected length.

3. A headband in accordance with claim 2, wherein:
the first guide is a first opening in the headband element, through which the support band is passed from the concave inner side to the convex outer side of the headband element, and
the locking device can be actuated on the convex outer side for locking and unlocking the support band.

4. A headband in accordance with claim 2, wherein the locking device includes a pin on the headband element, the support band is provided with a plurality of holes, and the support band can be fixed to the support band by hooking one of its holes over the pin.

5. A headband in accordance with claim 1, wherein the support band is provided with a cushion.

6. A headband in accordance with claim 1, further comprising a tensioning strap which extends between the headband element and the support band and includes a section of adjustable length.

7. A headband in accordance with claim 6, wherein the tensioning strap includes a first section extending laterally between the support band and the headband element.

8. A headband in accordance with claim 7, wherein the tensioning strap includes a second section extending between the support band and the headband element above the first section.

9. A headband in accordance with claim 6, wherein:
the headband element is provided with a second guide through which a selectable length of the tensioning strap is passed, and
the headband element has a locking device for locking the tensioning strap passed through the second guide thereby fixing said selected length.

10. A headband in accordance with claim 9, wherein:
the second guide is a second opening in the headband element, through which the tensioning strap is passed from the concave inner side to the convex outer side of the headband element, and
the locking device can be actuated on said convex outer side for locking and unlocking the tensioning strap.

11. A headband in accordance with claim 10, wherein the locking device includes a pin on the headband element, the tensioning strap is provided with a plurality of holes, and the tensioning strap can be fixed by hooking one of its holes over the pin.

12. A headband in accordance with claim 4, wherein the support band and the tensioning strap can be fixed to the same pin.

13. A headphone with a headband in accordance with claim 1.
